(19) United States
(12) Patent Application Publication
(10) Pub. No.: US 2008/0018441 A1
(43) Pub. Date: Jan. 24, 2008

(54) Tire failure detection

(76) Inventor: John Robert Orrell, Advance, NC (US)

Correspondence Address: QUALCOMM INCORPORATED, 5775 MOREHOUSE DR., SAN DIEGO, CA, 92121, US

(21) Appl. No.: 11/490,229

(22) Filed: Jul. 19, 2006

(51) Int. Cl. B60C 23/00

(52) U.S. Cl. 340/438; 340/442

(57) ABSTRACT

Detection of an impending tire failure event is accomplished using a transducer placed near a set of tires on a vehicle. A processor detects a characteristic sound indicative of an impending tire failure event in conjunction with sound information received from the transducer. A warning indication is transmitted by a transceiver to the driver of the vehicle and/or to a remote location in connection with the detection of a characteristic sound indicative of an impending tire failure.

### BACKGROUND

Truck tires are a relatively expensive commodity. Wear, due to friction generated by contact of a tire tread with the road surface, can result in a tire blow out. In order to save money, subject to the amount of wear, tires are given a retread, rather than being replaced. Should a blow out occur, a potentially very dangerous situation can arise given the size and weight of trucks and their cargo. Further, depending upon what is being hauled at the time of the blow out, a hazardous situation can be further exacerbated. Retread tires pose more of a hazard than new or newer tires. U.S. Federal law recognizes this through prohibiting retreads on the front wheels of vehicles since blow outs on tires on front wheels, which of course steer a vehicle, pose a greater risk of causing a vehicle to veer out of control than is the case with a rear cab wheel or a trailer wheel.

Another economic consideration is also involved concerning retread tires-that being the value of a truck and of the cargo carried by the truck. The value of the cab, trailer and cargo can often exceed $20 million. Not only can a blown tire put life and limb in jeopardy, high valued property can also be destroyed.

Hazardous cargo poses even more of a risk. Explosives and hazardous waste can present destructive, life-threatening hazards during accidents caused by a blown retread tire while in transit.

A need exists to detect an imminent failure of a retread tire.

### BRIEF DESCRIPTION OF THE DRAWINGS

FIG. 1 illustrates a block diagram of a system implementing a sound monitoring solution for warning of an impending retread tire failure.

FIG. 2 illustrates a block diagram of a system implementing a sound monitoring solution, using spectrum analysis in the frequency domain, for warning of an impending retread tire failure.

FIG. 3 illustrates a front view/schematic drawing of a two tire set, mounted on wheels, located on an axle through which a speed sensor is connected.

FIG. 4 illustrates a front view/schematic drawing of a set of four tires, which includes a double two tire set, mounted on wheels, located on an axle through which a speed sensor is connected.

Applicable reference numbers and symbols have been carried forward.

### DETAILED DESCRIPTION

Retread tires have a characteristic seam where the retread material is applied. Revolution of the tire in contact with a road surface produces a “thump” sound. In connection with monitoring the sound volume of the “thump,” an indication of an impending tire failure can be detected. When the “thump” is monitored, one can determine when a predetermined threshold level is exceeded. Further, an increase in sound volume of the “thump” over a period of time is characteristic of retread tire failure.

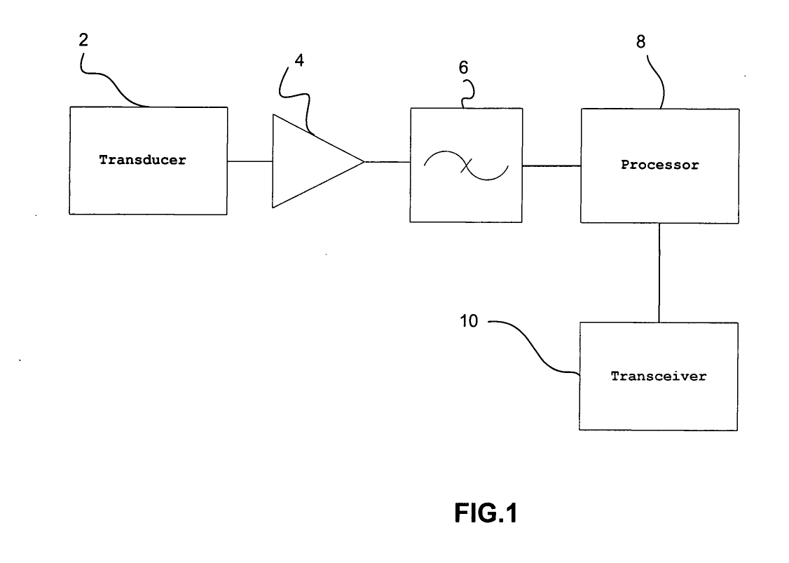

FIG. 1 illustrates a block diagram of a system implementing a sound monitoring solution for warning of an impending retread tire failure.

Transducer 2 detects sound vibrations produced by a retread tire. These vibrations are amplified by amplifier 4 connected to transducer 2. Next, signal conditioning is provided by filtering the amplified sound fed from amplifier 4 through filter 6. Filter 6 is designed to filter out all but the characteristic “thump” sound indicative of a retread tire failure. In one embodiment, filter 6 low pass filters out substantial background noise, in an effort to leave only the “thump” sound. In other embodiments, other filter types, such as band pass filters, can implement the filtering function depending upon the type of filtering characteristic identified. Even high pass filters are contemplated should the characteristic “thump” constrain as much.

The output from filter 6 is provided to processor 8 for analysis and comparison of the “thump” sound with predetermined sound data identified as being indicative of an impending tire failure. In conjunction with a determination made by processor 8 that the “thump” sound comports with characteristic information identified as being indicative of tire failure, a signal is received by transceiver 10, which can transmit a warning indication to the driver of the vehicle and/or to a remote location. Transceiver 10 may also receive from a remote location information that updates tire information, including characteristic sound information accessed by processor 8 in detecting an impending tire failure event.

In one aspect, processor 8 and transceiver 10 are connected through a 7 pin connector, commonly used with tractor trailers, using a TrailerTRACS® Asset Management System by QUALCOMM Incorporated or Power Line Carrier (PLC) for trucks. The TrailerTRACS® Asset Management System provides position reports, when connected to a QUALCOMM mobile communications system (e.g., a mobile station, the system disclosed herein, etc.), including a positive tractor/trailer ID with every connect and disconnect, continuous position reports and reference operations. PLC for trucks provides a conduit for the flow of information and is a communication protocol that, in and of itself, requires no additional wires or cables to allow two-way tractor-trailer communications (such as anti-lock braking system (ABS) information and a host of other data to and from the tractor). In another aspect, devices and systems communicate through transceiver 10 according to industry standard SAE J-1587 protocols.

The warning indication to the driver may include an audible warning produced by a siren, buzzer, a beeper, a speech synthesizer, etc. Further, in a manner similar to an ABS warning light, an enunciator on the dashboard of a vehicle may signal, solely or in conjunction with an audible warning, a tire problem to the vehicle driver.

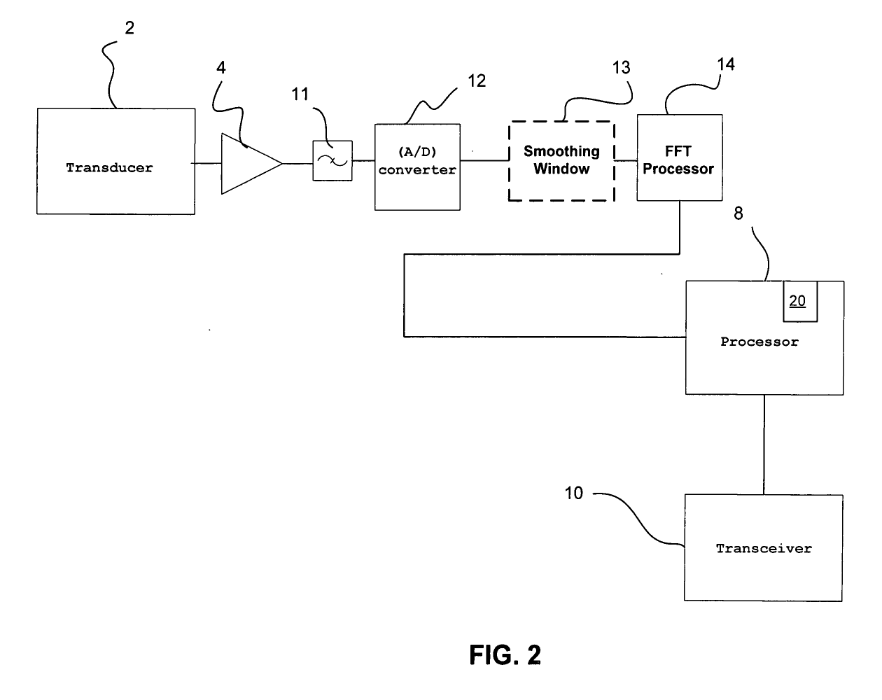

FIG. 2 illustrates a block diagram of a system implementing a sound monitoring solution using spectrum analysis in the frequency domain, for warning of an impending retread tire failure. Often, familiarity with time domain measurements usually arises through the use of data acquisition hardware since this hardware usually acquires time domain measurements. However, sound quality determinations and analysis are usually best conducted in the frequency domain. Frequency domain analysis allows isolation of distortion and extraction of individual signals from a complex multi-frequency spectrum. With reference to FIG. 2, analog-to-digital (A/D) converter 12 converts the sampled analog signal information received through transducer 2 from amplifier 4. In one embodiment, the analog signal is low-pass filtered by filter 11 to ensure that nothing above half the sampling frequency can enter the system consistent with the requirements of Nyquist sampling. Therefore, filter 11 serves as an anti-aliasing filter. Filter 11 also serves to eliminate spurious noise components. Processor 14 performs Fast Fourier Transforms (FFTs) on the digital data received from A/D converter 12. In connection with conversion to the frequency domain, a time domain signal is assumed to be composed of a sum of sinusoids at different frequencies. The FFT is a mathematical algorithm that allows a computer (e.g., processor) to perform a discrete Fourier transform (DFT). The algorithm allows computation of the magnitude of each sinusoid, from the sum of sinusoids, in relation to frequency. This allows a plot of magnitude vs. frequency.

Optional smoothing window 13 conditions the signal prior to FFT transformation. Smoothing window 13 reduces the magnitude of a sampled signal near its boundaries in order to reduce spectral leakage resulting from boundary discontinuities. The spectral leakage manifests itself in the form of noise in the frequency domain FFT. Smoothing window 13 can be implemented using a window selected from the following windows: Uniform (none), Hanning, Hamming, Flattop, Blackman-Harris, Exact Blackman, Blackman, or the like. Each window has its own characteristic and is chosen based on the signal frequency content of the identified “thump.” As with the embodiment shown in FIG. 1, processor 8 identifies the requisite “thump” indicating an impending tire failure. The thump signal frequency components are determined in connection with tests conducted on retread tires determined to be on the verge of failing as compared with new tires or newer tires or less worn retread tires. Should the signal contain strong interfering frequency components distant from the frequency of interest associated with the identified thump sound, a window with a high side lobe roll-off rate is preferably chosen. If there are strong interfering signals near the frequency of interest associated with the identified thump sound, a window is preferably chosen with a low maximum side lobe level. Should the frequency of interest, associated with the identified thump sound, contain two or more signals very near to each other, spectral resolution becomes more of a factor in the choice of a window. Consequently, a window is chosen with a very narrow main lobe. Further, should the amplitude of a single frequency component of the “thump” be more important than the exact location of the signal component, within a range of frequencies, a window having a wide main lobe is preferably chosen. A Uniform window is preferably used when the “thump” is identified as having a signal spectrum with relatively flat or broadband frequency content. The Uniform window is tantamount to using no window at all.

Processor 14 provides the power spectrum that indicates the energy content in a signal at a given frequency. Thus, the squared magnitude of a signal at a given frequency is indicated by the power spectrum. This frequency domain representation does not include phase information. A condition indicative of an impending tire failure can be identified on the basis of energy content exceeding a threshold at a given frequency associated with the “thump.” In connection with this condition, a warning indication is sent by processor 8 to transceiver 10 for transmission of a warning indication to a vehicle's driver and/or a remote location (via terrestrial and/or satellite communications) such a dispatch station, vehicle fleet owner, etc. In an alternative embodiment, processor 14 determines the power spectral density (energy per unit bandwidth) associated with the FFT information it processes. Therefore, the “thump” can be identified on the basis of energy content occurring over a range of frequencies. A condition indicative of an impending tire failure can be identified on the basis of energy content exceeding a threshold over a range of frequencies associated with the identified “thump.” As with the previously described embodiment, in connection with a thump having energy exceeding a predetermined threshold, a warning indication is sent by processor 8 to transceiver 10 for transmission of a warning indication to a vehicle's driver and/or a remote location (via terrestrial and/or satellite communications) such a dispatch station, vehicle fleet owner, etc. In one embodiment, the functions accomplished by processor 8 and processor 14 are physically embodied within a single processor.

In order to determine the alarm thresholds, a series of calibration tests can be conducted on a standard set of tires (including new, newer and retread tires) over the speed, pressure and tread wear ranges of interest to create a look-up table a priori for each platform.

Since the speed of the vehicle directly determines the speed at which the tire on the wheel of a vehicle is rotating, speed must be taken into account since the rotational speed of a tire will directly influence the sound (e.g., pitch) of the “thump.” Consequently, the threshold level at which a warning indication is warranted is determined in conjunction with a series of calibration tests conducted on a standard set of tires rotating at various speeds, having various tread wear ranges and having various inflation pressures. Look-up table 20, embodied in a memory (not shown) connected to or embedded within processor 8, is encoded with data to facilitate the identification of a characteristic “thump” for a particular tire type rotating at a particular speed or within a range of speeds. Specifically, certain data in lookup table 20 may be identified as being indicative of an impending tire failure. Further, look-up table 20 may also include reference entries for tire inflation, which can also be figured into the determination of a characteristic “thump” indicative of an impending tire failure. Consequently, look-up table 20 provides a ready reference of tire failure characterizations. Look-up table 20 may be updated “on-the-fly” while the vehicle is being operated on the road through transceiver 10 in conjunction with storing information within the memory (not shown) connected to or embedded within processor 8.

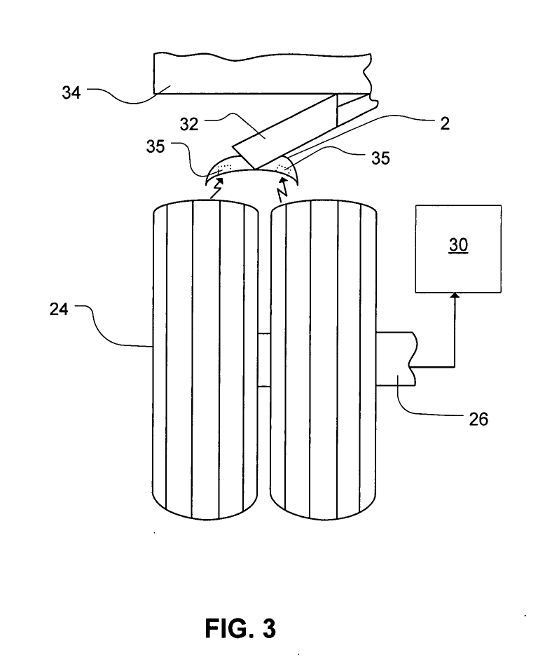

FIG. 3 illustrates a front view/schematic drawing of a two tire set 24, mounted on wheels (not shown), located on axle 26 to which speed sensor 30 is connected. Speed sensor 30 measures the rotational speed of axle 26. In another embodiment, speed sensor 30 measures the rotational speed, of one of the tires from the set of tires 24. Transducer 2 extends from pole 32 attached to the underside of a vehicle shown in cut-away section 34. Transducer 2 detects sound emissions (generally indicated by arrows). In one embodiment, transducer 2 with pole 32 can form a boom microphone. This microphone may represent a dynamic microphone (one having a movable induction coil) or a condenser microphone (one having a diaphragm acting as one plate of a capacitor). In other embodiments, transducer 2 can form a piezo microphone, a carbon microphone, a ribbon microphone, or an electret microphone. Further, the microphone may be chosen according to the polar recording pattern desired. The polar pattern provides an indication of the sensitivity of a microphone to sounds arriving at different angles about its central axis and it presents a locus of points over which the same signal level is output, given a sound pressure level generated from that point. In one embodiment, two microphones are included within transducer 2. Each microphone 35 possesses a polar pattern configured to pickup sounds from an associated tire from tire set 24. This allows detection of the listened for characteristic “thump,” indicative of impending tire failure, with greater discernability as it relates to an individual tire. In other embodiments, it may not be possible to discern which tire is emitting the characteristic “thump.” However, such identification can be made in conjunction with a visual inspection after receipt of a warning indication. In yet another embodiment, transducer 2 may represent a piezo-electric pick-up including a piezo-electric crystal (not shown). The piezo-electric crystal can pickup sound vibrations from the tires and convert the sound to analog electrical impulses.

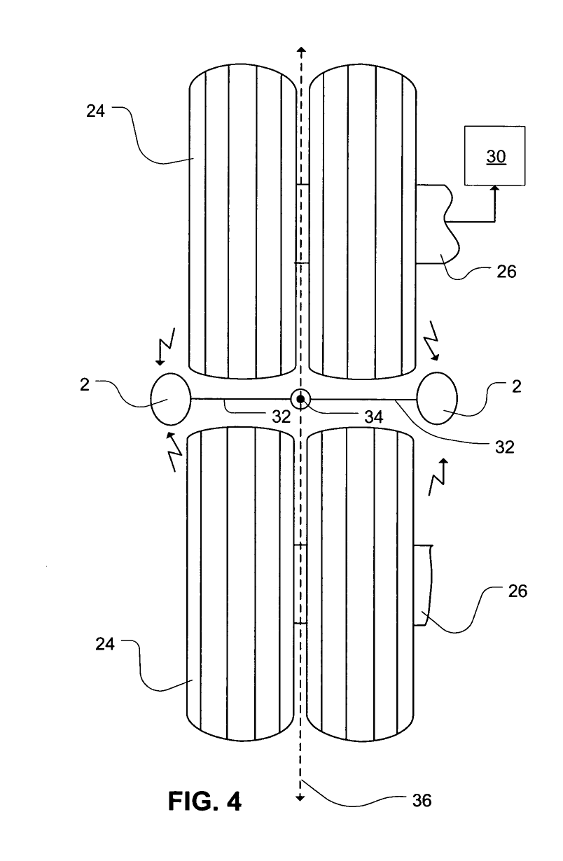

FIG. 4 illustrates a front view/schematic drawing of a set of four tires, which includes a double two tire set 24, mounted on wheels (not shown), located on axis 26 to which speed sensor 30 is connected. The double two tire set 24 is representative of rear tires, which are present on, for instance, trailers towed in relation to a tractor-trailer configuration, or the like. Transducer 2 may include any of the microphone or piezo-electric crystal pickup configurations or embodiments discussed above with respect to FIG. 3. Pole 32 may extend from vehicle 34 from a location centered among the four tires composed of the combination of each two tire set 24. Speed sensor 30 need only be included on a single axle if the assumption is made that all tires spin at the same rate. This assumption may not be strictly true. However, it should be sufficient for the purposes herein. As with one of the embodiments of FIG. 3, each transducer 2 may include two microphones (not shown) with each microphone having a polar pattern configured to detect sounds preferentially from a pair of tires, each from one of the two tire sets 24. Consequently, in this embodiment, it may be possible to more readily detect the characteristic “thump” produced by a specific pair of tires. In an embodiment having two microphones within each transducer 2, the pair of tires from which the characteristic “thump” is produced can be identified on a particular side of each two tire set 24 about axis 36. In this embodiment, visual inspection of the tires, for which a warning indication has been issued, can result in specific identification of the particular tire subject to an impending failure. Alternatively, each transducer 2 may include multiple microphones with a suitable polar pattern configured to detect sounds emitted by an associated individual tire. In embodiments wherein transducer 2 includes a piezo-electric crystal, a warning indication will identify an impending tire failure among the four tires of each two tire set 24. Visual inspection will allow identification of the specific tire subject to impending failure from among the four tires.

While transducer 2 is located on the transportation vehicle (e.g. trailer, tractor, truck, etc.), remote signal processing and warning indication as described herein can take place at a remote location in conjunction with transceiver 10, which is also resident at the vehicle location. Consequently, minimal processing and information storage capability need exist at the vehicle. Communications with a remote location, at which such processing and control takes place, can occur at specific intervals or in within time intervals determined statistically. Such remote processing capability can be accomplished, for instance, by a server.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. For instance, although primary application of the invention lies with a retread tire, it is contemplated that the invention can be applied to non-retread tires, as well, in conjunction with identifying characteristic sounds indicative of an impending tire failure.

What is claimed is:

1. A system for detecting an impending tire failure comprising:
a transducer operable detect sounds and to produce electrical signals corresponding to detected sounds;
a processor coupled to said transducer and being operable to identify a sound characteristic of an impending tire failure; and
a transceiver operable to transmit a warning indication in connection with identification by said processor of said impending tire failure.

2. A system as recited in claim 1 wherein said transducer is selected from the group consisting of a piezo-electric pickup, a condenser microphone, a dynamic microphone or a combination thereof.

3. A system as recited in claim 1 wherein said transducer includes at least one microphone consisting of a condenser microphone, a dynamic microphone, or a combination thereof, said condenser microphone and dynamic microphone being selected from the group consisting of a piezo microphone, a carbon microphone, a ribbon microphone, or an electret microphone.

4. A system as recited in claim 1 further including a memory operable for storing a look-up table including characteristic information pertaining to at least one tire.

5. A system as recited in claim 4 wherein said information includes retread tire information.

6. A system as recited in claim 1 wherein said transceiver is capable of transmitting a warning signal to the operator of a vehicle in response to receiving an indication from said processor of a tire sound characteristic indicative of an impending tire failure event.

7. A system as recited in claim 1 wherein said transceiver is capable of transmitting a warning signal to a remote location in response to receiving an indication from said processor of a tire sound characteristic indicative of an impending tire failure event.

8. A system as recited in claim 7 wherein said transceiver is capable of transmitting said warning signal using communications consisting of terrestrial communications, satellite communications or a combination thereof.

9. A system as recited in claim 1 further including a processor operable to convert sampled analog time domain data from said transducer into frequency domain data.

10. A system as recited in claim 9 wherein said processor is operable to convert said analog time domain data into Fourier Transform data.

11. A system as recited in claim 10 wherein said Fourier transform data is Fast Fourier Transform (FFT) data.

12. A system as recited in claim 9 wherein said processor is operable to convert said analog time domain data into power spectrum data.

13. A system as recited in claim 9 wherein said processor is operable to convert said analog time domain data into power spectral density data.

14. A system as recited in claim 1 wherein said tire is a retread tire.

15. A transducer assembly adapted to connect to the frame of a vehicle comprising:
a transducer; and
a pole connected to said transducer, said transducer assembly being further adapted to be deposed in the vicinity of a vehicle tire.

16. A transducer as recited in claim 15 wherein said transducer includes at least one microphone.

17. A transducer as recited in claim 15 wherein said transducer includes a piezo-electric element.

18. A method of detecting an impending tire failure on a vehicle comprising:
taking samples of sounds emitted near a tire;
converting said samples of sounds to digital data;
computing Fourier Transforms using said digital data;
determining whether a threshold of a function of said Fourier Transforms has been exceeded; and
issuing a warning indication in connection with said threshold being exceeded.

19. A method as recited in claim 18 wherein said function is selected from functions consisting of a function of power spectrum or a function of power spectral density.

20. A method as recited in claim 18 wherein said warning indication is issued to a driver of a vehicle.

21. A method as recited in claim 18 wherein said warning indication is issued to a remote location.

22. A method as recited in claim 18 wherein said warning indication consists of a sound produced by a siren, a buzzer, a beeper, a speech synthesizer and a combination thereof.

23. A method as recited in claim 18 wherein said tire is a retread tire.

24. A method as recited in claim 18 further including determining whether a threshold of a function of said Fourier Transforms has been exceeded in connection with using comparison information received via a wireless transmission.

25. A method as recited in claim 18 wherein at least one of said converting, computing, determining and issuing steps occurs at a remote location from said vehicle.
